(19) United States
(12) Patent Application Publication
(10) Pub. No.: US 2026/0164430 A1
(43) Pub. Date: Jun. 11, 2026

(54) METHOD AND APPARATUS FOR UPLINK TRANSMISSION TO MULTIPLE TRANSMISSION-RECEPTION POINTS IN MOBILE COMMUNICATIONS

(71) Applicant: MEDIATEK INC., Hsinchu City (TW)

(72) Inventors: Yi-Ru CHEN, Hsinchu City (TW); Cheng-Rung TSAI, Hsinchu City (TW)

(73) Assignee: MEDIATEK INC., Hsinchu City (TW)

(21) Appl. No.: 19/472,814

(22) PCT Filed: Jun. 19, 2024
(86) PCT No.: PCT/CN2024/099990

§ 371 Date: Oct. 6, 2025

Related U.S. Application Data
(60) Provisional application No. 63/518,113, filed on Aug. 8, 2023.

(51) Int. Cl. H04W 72/1268; H04L 5/00

(52) U.S. Cl. CPC H04W 72/1268; H04L 5/0053; H04L 5/0094

(57) ABSTRACT

Various solutions for uplink (UL) transmission to multiple transmission-reception points (TRPs) with respect to an apparatus in mobile communications are described. The apparatus may determine a first physical uplink shared channel (PUSCH) including a channel state information (CSI) report. The apparatus may determine a second PUSCH including a data. The first PUSCH and the second PUSCH may be associated with a control resource set (CORESET) pool index value. The apparatus may determine whether the first PUSCH overlaps with the second PUSCH in time domain. The apparatus may transmit the second PUSCH including the data in an event that the first PUSCH overlaps with the second PUSCH in time domain.

### CROSS REFERENCE TO RELATED PATENT APPLICATION(S)

The present disclosure is part of a non-provisional application claiming the priority benefit of U.S. Patent Application Ser. No. 63/518,113, filed 8 Aug. 2023, the content of which herein being incorporated by reference in its entirety.

### TECHNICAL FIELD

The present disclosure is generally related to mobile communications and, more particularly, to uplink transmission to multiple transmission-reception points with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, the concept of transmission-reception point (TRP) is introduced. In particular, the TRP is a network node equipped with a set of geographically co-located antennas (e.g., antenna array) supporting transmission point (TP) and/or reception point (RP) functionalities.

Furthermore, to enhance the communication flexibility, technology of multiple TRPs (MTRP) has been developed. Under the architecture of MTRP, serving cell(s) may schedule a UE from multiple TRPs, so that to provide better coverage, reliability and/or data rates. In some scenarios, to schedule the UE under the architecture of MTRP, multiple downlink control information (multi-DCI) is utilized, which means that the UE is scheduled by DCIs from different TRPs. Accordingly, there may be multiple physical uplink shared channels (PUSCHs) scheduled to the UE based on the DCIs. However, when the scheduled PUSCHs overlap with each other, the UE may not be able to handle this situation that may cause significant transmission errors, especially if the overlapping PUSCHs are associated with the same TRP.

Accordingly, how to handle the situation of that the scheduled PUSCHs (particularly those associated with the same TRP) overlap under the architecture of MTRP become important issues in the newly developed wireless communication network, and there is an urgent need to provide proper schemes to handle the situation.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to uplink (UL) transmission to multiple transmission-reception points (TRPs) with respect to apparatus in mobile communications.

In one aspect, a method may involve an apparatus determining a first physical uplink shared channel (PUSCH) including a channel state information (CSI) report. The method may also involve the apparatus determining a second PUSCH including a data. The first PUSCH and the second PUSCH may be associated with a control resource set (CORESET) pool index value. The method may further involve the apparatus determining whether the first PUSCH overlaps with the second PUSCH in time domain. The method may further involve the apparatus transmitting the second PUSCH including the data in an event that the first PUSCH overlaps with the second PUSCH in time domain.

In one aspect, an apparatus may comprise a transceiver which, during operation, wirelessly communicates with at least one network node of a wireless network. The apparatus may also comprise a processor communicatively coupled to the transceiver. The processor, during operation, may perform operations comprising determining a first PUSCH including a CSI report. The processor may also perform operations comprising determining a second PUSCH including a data. The first PUSCH and the second PUSCH may be associated with a CORESET pool index value. The processor may further perform operations comprising determining whether the first PUSCH overlaps with the second PUSCH in time domain. The processor may further perform operations comprising transmitting, via the transceiver, the second PUSCH including the data in an event that the first PUSCH overlaps with the second PUSCH in time domain.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a block diagram of an example communication system in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to uplink (UL) transmission to multiple transmission-reception points (MTRP) with respect to apparatus in mobile communications. According to the present disclosure, a number of possible solutions may be implemented separately or jointly. That is, although these possible solutions may be described below separately, two or more of these possible solutions may be implemented in one combination or another.

Regarding to the present disclosure, a user equipment (UE) compatible with MTRP techniques may receive downlink control information (DCI) from a network node. According to different DCIs, the UE may determine different physical uplink shared channels (PUSCHs). In some scenarios, one PUSCH may include a channel state information (CSI) report, another PUSCH may include data and both PUSCHs are associated with same control resource set (CORESET) pool index value (i.e., associated with same network node such as TRP.) In these scenarios, the UE may determine whether the PUSCHs overlap with each other in time domain. If positive, the UE may transmit the PUSCH including the data to the network node (e.g., TRP) corresponding to the CORESET pool index value. More specifically, the UE may drop the PUSCH including the CSI report and only transmit the PUSCH including the data to the network node (e.g., TRP) corresponding to the CORESET pool index value.

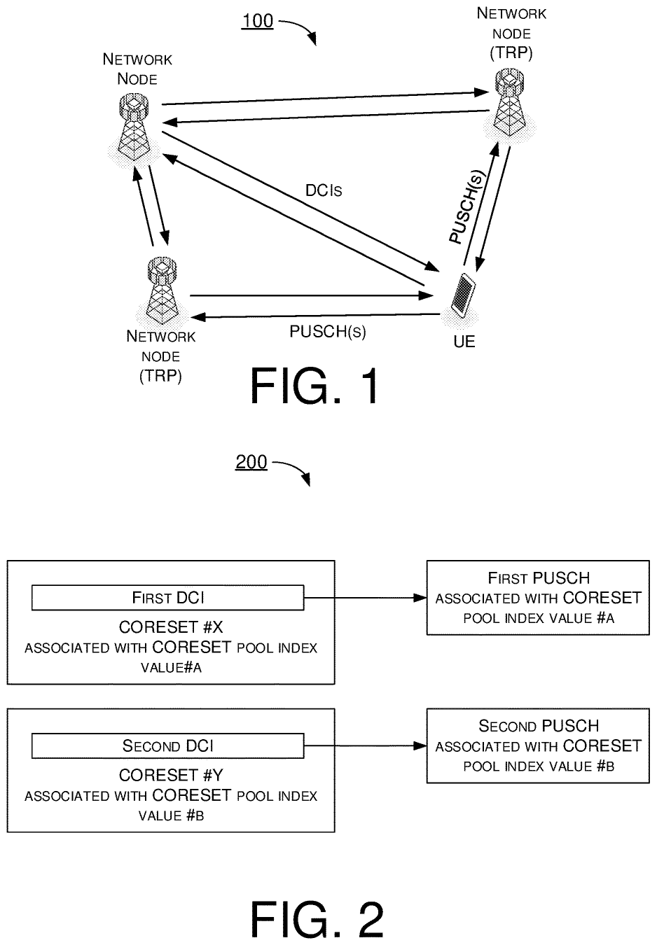

FIG. 1 illustrates an example scenario 100 under schemes in accordance with implementations of the present disclosure. Scenario 100 involves at least one network node, a UE and TRPs, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes which include one or more than one TRPs. The UE may be compatible with MTRP techniques.

In some embodiments, the UE may receive DCIs from the network node. For example, the UE receives the DCIs from the network node directly (or via at least one of the TRPs). According to one of the DCIs, the UE may determine a first PUSCH including a CSI report (e.g., a semi-persistent CSI report.) In other words, the UE may determine the first PUSCH for transmitting the CSI report based on the DCI. According to another DCI, the UE may determine a second PUSCH including a data.

In an event that the first PUSCH and the second PUSCH are determined to be associated with the same CORESET pool index value (i.e., the first PUSCH and the second PUSCH are determined to be transmitted to the same TRP), the UE may determine whether the first PUSCH overlaps with the second PUSCH in time domain. If the first PUSCH is determined to be overlapped with the second PUSCH in time domain, the UE may transmit the second PUSCH including the data to the TRP corresponding to the CORESET pool index value.

More specifically, because the second PUSCH including the data may have higher priority than the first PUSCH including the CSI report, the UE may determine not to transmit (i.e., the UE may drop/suspend/postpone) the first PUSCH including the CSI report but only transmit the second PUSCH including the data to the TRP corresponding to the CORESET pool index value.

In some implementations, the first PUSCH may be determined not to be transmitted according to a capability information of the UE. In particular, in the event that the capability of the UE is limited (e.g., limited number of transmitting units/receiving units), the UE may not be able to transmit all PUSCHs to the same TRP during a specific time interval. Therefore, the first PUSCH with lower priority may be dropped by the UE according to the capability information of the UE.

In some implementations, the first PUSCH and the second PUSCH may be determined to be associated with the same TRP according to the CORESET pool index value. FIG. 2 illustrates an example scenario 200 under schemes in accordance with implementations of the present disclosure. For example, based on reception of a first DCI, the UE determines: (1) a CORESET #X, which is associated with a CORESET pool index value #A, utilized with a first TRP; and (2) a first PUSCH scheduled by the first DCI corresponding to the CORESET #X to be transmitted to the first TRP. Accordingly, the first PUSCH to be transmitted to the first TRP is determined to be associated with the CORESET pool index value #A. Based on reception of a second DCI, the UE determines: (1) a CORESET #Y, which is associated with a CORESET pool index value #B, utilized with a second TRP; and (2) a second PUSCH scheduled by the second DCI corresponding to the CORESET #Y to be transmitted to the second TRP. Accordingly, the second PUSCH to be transmitted to the second TRP is determined to be associated with the CORESET pool index value #B.

Then, if the CORESET pool index value #A and the CORESET pool index value #B are the same (i.e., A=B), it means that the CORESET #X and the CORESET #Y are the same CORESET. Accordingly, the UE determines that the first TRP utilizing the CORESET #X and the second TRP utilizing the CORESET #Y are the same TRP. Furthermore, the UE determines that the first PUSCH associated with the CORESET pool index value #A and the second PUSCH associated with the CORESET pool index value #B are to be transmitted to the same TRP (i.e., the first PUSCH and the second PUSCH are associated with the same TRP.)

In some implementations, the UE may receive a higher layer configuration including the CORESET pool index value from the network node (directly or via at least one of the TRPs.) The higher layer configuration may include a radio resource control (RRC) configuration.

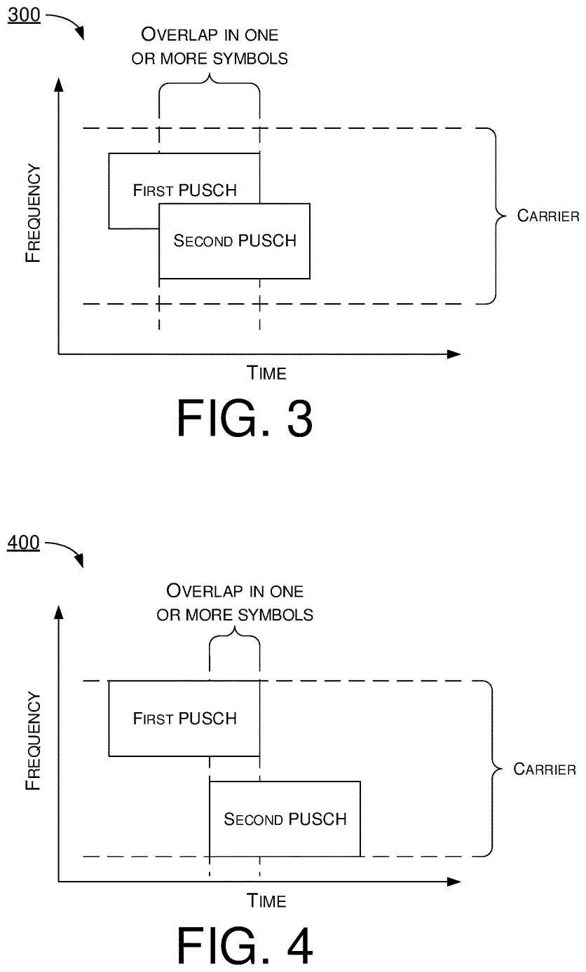

FIGS. 3 and 4 illustrate example scenarios 300 and 400 under schemes in accordance with implementations of the present disclosure. In some implementations, the first PUSCH and the second PUSCH associated with the same CORESET pool index value (i.e., associated with the same TRP) may overlap in one or more symbols on a same carrier. In addition, the first PUSCH and the second PUSCH overlapped in one or more symbols on the same carrier: (1) may fully or partially overlap in frequency domain; or (2) may not overlap in frequency domain.

For a detailed example, after receiving the RRC configuration, the UE is configured by a parameter (e.g., PDCCH-Config defined in 3rd Generation Partnership Project (3GPP) specification) that contains two different values (e.g., 0 and 1) of CORESET pool index value (e.g., coresetPoolIndex defined in 3GPP specification) associated with two CORESETs. The UE is configured with a function enablement parameter (e.g., enableSTx2PofmDCI defined in 3GPP specification). When the UE determines that two overlapping PUSCHs are associated with the same CORESET pool index value (i.e., the two overlapping PUSCHs are associated with the same TRP), only the PUSCH with higher priority is going to be transmitted, and the PUSCH with lower priority is going to be dropped. In some cases, if the UE would transmit a first PUSCH that includes semi-persistent CSI reports and a second PUSCH that includes an UL-SCH (i.e., UL shared channel data) on the same carrier, and the first PUSCH transmission would overlap with the second PUSCH transmission in time domain, the UE does not transmit the first PUSC but transmits the second PUSCH. The UE expects that the first and second PUSCH transmissions satisfy the above timing conditions for PUSCH transmissions that overlap in time when at least one of the first or second PUSCH transmissions is in response to a DCI format detection by the UE.

### Illustrative Implementations

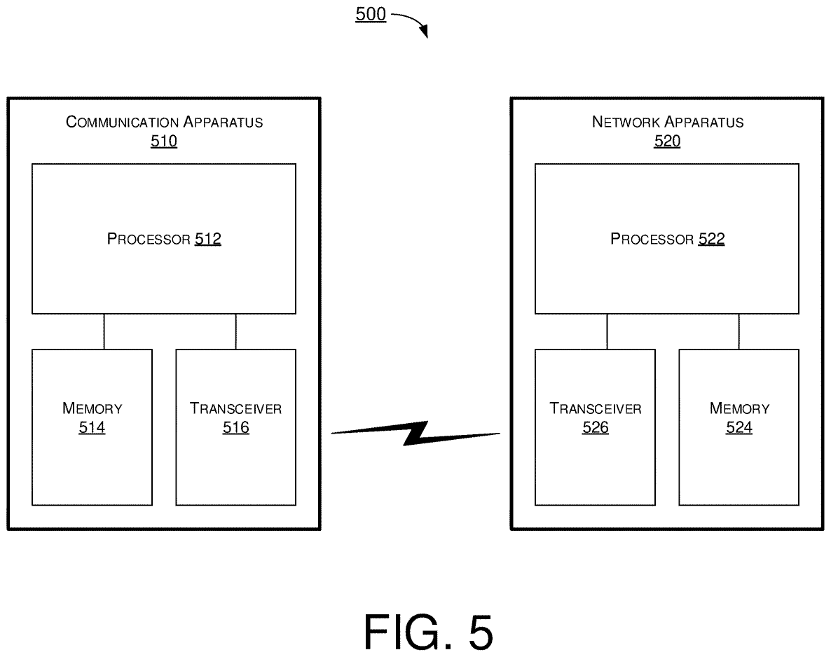

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to UL transmission to multiple TRPs with respect to user equipment and network apparatus in mobile communications, including scenarios/schemes described above as well as process 600 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of a network apparatus, which may be a network node such as a satellite, a base station, a TRP, a small cell, a router or a gateway. For instance, network apparatus 520 may be implemented in an eNodeB in an LTE network, in a gNB in a 5G/NR, IoT, NB-IoT or IIoT network or in a satellite or base station in a 6G network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including autonomous reliability enhancements in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, communication apparatus 510 may further include a memory 514 coupled to processor 512 and capable of being accessed by processor 512 and storing data therein. In some implementations, network apparatus 520 may also include a transceiver 526 coupled to processor 522 and capable of wirelessly transmitting and receiving data. In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively. To aid better understanding, the following description of the operations, functionalities and capabilities of each of communication apparatus 510 and network apparatus 520 is provided in the context of a mobile communication environment in which communication apparatus 510 is implemented in or as a communication apparatus or a UE and network apparatus 520 is implemented in or as a network node and/or a TRP of a communication network.

In some implementations, processor 512 may determine a first PUSCH including a CSI report. Processor 512 may determine a second PUSCH including a data. The first PUSCH and the second PUSCH may be associated with a CORESET pool index value. Processor 512 may determine whether the first PUSCH overlaps with the second PUSCH in time domain. Processor 512 may transmit, via transceiver 516, the second PUSCH including the data to a network node corresponding to the CORESET pool index value in an event that the first PUSCH overlaps with the second PUSCH in time domain.

In some implementations, processor 512 may determine not to transmit the first PUSCH including the CSI report.

In some implementations, the first PUSCH may be determined not to be transmitted according to a capability information of the communication apparatus 510.

In some implementations, the capability information of the communication apparatus 510 may include a number of transmitting units and a number of receiving units.

In some implementations, processor 512 may receive, by transceiver 516, a high layer configuration including the CORESET pool index value.

In some implementations, the higher layer configuration may include an RRC configuration.

In some implementations, the CSI report may include a semi-persistent CSI report.

In some implementations, the first PUSCH may overlap with the second PUSCH in one or more symbols on a same carrier.

In some implementations, the first PUSCH may fully or partially overlap with the second PUSCH in frequency domain.

In some implementations, the first PUSCH may not overlap with the second PUSCH in frequency domain.

### Illustrative Processes

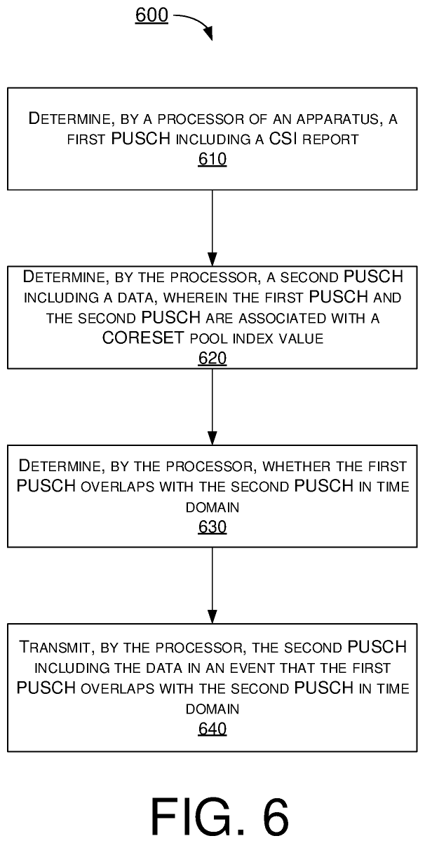

FIG. 6 illustrates an example process 600 in accordance with an implementation of the present disclosure. Process 600 may be an example implementation of above scenarios/schemes, whether partially or completely, with respect to UL transmission to multiple network nodes including TRPs of the present disclosure. Process 600 may represent an aspect of implementation of features of communication apparatus 510. Process 600 may include one or more operations, actions, or functions as illustrated by one or more of blocks 610 to 640. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510. Process 600 may begin at block 610.

At block 610, process 600 may involve processor 512 of communication apparatus 510 determining a first PUSCH including a CSI report in. Process 600 may proceed from block 610 to block 620.

At block 620, process 600 may involve processor 512 of communication apparatus 510 determining a second PUSCH including a data. The first PUSCH and the second PUSCH may be associated with a CORESET pool index value. Process 600 may proceed from block 620 to block 630.

At block 630, process 600 may involve processor 512 of communication apparatus 510 determining whether the first PUSCH overlaps with the second PUSCH in time domain. Process 600 may proceed from block 630 to block 640.

At block 640, process 600 may involve processor 512 of communication apparatus 510 transmitting the second PUSCH including the data in an event that the first PUSCH overlaps with the second PUSCH in time domain.

In some implementations, process 600 may involve processor 512 of communication apparatus 510 determining not to transmit the first PUSCH including the CSI report.

In some implementations, the first PUSCH may be determined not to be transmitted according to a capability information of the communication apparatus 510.

In some implementations, the capability information of the communication apparatus 510 may include a number of transmitting units and a number of receiving units.

In some implementations, process 600 may involve processor 512 of communication apparatus 510 receiving a high layer configuration including the CORESET pool index value.

In some implementations, the higher layer configuration may include an RRC configuration.

In some implementations, the CSI report may include a semi-persistent CSI report.

In some implementations, the first PUSCH may overlap with the second PUSCH in one or more symbols on a same carrier.

In some implementations, the first PUSCH may fully or partially overlap with the second PUSCH in frequency domain.

In some implementations, the first PUSCH may not overlap with the second PUSCH in frequency domain.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a first physical uplink shared channel (PUSCH) including a channel state information (CSI) report;
determining, by the processor, a second PUSCH including a data, wherein the first PUSCH and the second PUSCH are associated with a control resource set (CORESET) pool index value;
determining, by the processor, whether the first PUSCH overlaps with the second PUSCH in time domain; and
transmitting, by the processor, the second PUSCH including the data in an event that the first PUSCH overlaps with the second PUSCH in time domain.

2. The method of claim 1, further comprising:
determining, by the processor, not to transmit the first PUSCH including the CSI report.

3. The method of claim 2, wherein the first PUSCH is determined not to be transmitted according to a capability information of the apparatus.

4. The method of claim 3, wherein the capability information of the apparatus includes a number of transmitting units and a number of receiving units.

5. The method of claim 1, further comprising:
receiving, by the processor, a high layer configuration including the CORESET pool index value.

6. The method of claim 5, wherein the higher layer configuration includes a radio resource control (RRC) configuration.

7. The method of claim 1, wherein the CSI report includes a semi-persistent CSI report.

8. The method of claim 1, wherein the first PUSCH overlaps with the second PUSCH in one or more symbols on a same carrier.

9. The method of claim 8, wherein the first PUSCH fully or partially overlaps with the second PUSCH in frequency domain.

10. The method of claim 8, wherein the first PUSCH does not overlap with the second PUSCH in frequency domain.

11. An apparatus, comprising:
a transceiver which, during operation, wirelessly communicates with a network node; and
a processor communicatively coupled to the transceiver such that, during operation, the processor performs operations comprising:
determining a first physical uplink shared channel (PUSCH) including a channel state information (CSI) report;
determining a second PUSCH including a data, wherein the first PUSCH and the second PUSCH are associated with a control resource set (CORESET) pool index value;
determining whether the first PUSCH overlaps with the second PUSCH in time domain; and
transmitting, via the transceiver, the second PUSCH including the data in an event that the first PUSCH overlaps with the second PUSCH in time domain.

12. The apparatus of claim 11, wherein, during operation, the processor further performs operations comprising:
determining not to transmit the first PUSCH including the CSI report.

13. The apparatus of claim 12, wherein the first PUSCH is determined not to be transmitted according to a capability information of the apparatus.

14. The apparatus of claim 13, wherein the capability information of the apparatus includes a number of transmitting units and a number of receiving units.

15. The apparatus of claim 11, wherein, during operation, the processor further performs operations comprising:
receiving, via the processor, a high layer configuration including the CORESET pool index value.

16. The apparatus of claim 15, wherein the higher layer configuration includes a radio resource control (RRC) configuration.

17. The apparatus of claim 11, wherein the CSI report includes a semi-persistent CSI report.

18. The apparatus of claim 11, wherein the first PUSCH fully or partially overlaps with the second PUSCH in one or more symbols on a same carrier.

19. The apparatus of claim 18, wherein the first PUSCH fully or partially overlaps with the second PUSCH in frequency domain.

20. The apparatus of claim 18, wherein the first PUSCH does not overlap with the second PUSCH in frequency domain.
